(19) United States
(12) Patent Application Publication
(10) Pub. No.: US 2025/0148493 A1
(43) Pub. Date: May 8, 2025

(54) ELECTRONIC DEVICE AND METHOD FOR REDUCING POWER CONSUMPTION THEREOF

(71) Applicant: SAMSUNG ELECTRONICS CO., LTD., Suwon-si (KR)

(72) Inventor: Jonghwan Kim, Suwon-si (KR)

(73) Assignee: SAMSUNG ELECTRONICS CO., LTD., Suwon-si (KR)

(21) Appl. No.: 19/020,545

(22) Filed: Jan. 14, 2025

Related U.S. Application Data
(63) Continuation of application No. PCT/KR2023/011424, filed on Aug. 3, 2023.

(30) Foreign Application Priority Data
Sep. 22, 2022 (KR) 10-2022-0119966

(51) Int. Cl. G06Q 30/0207; H04N 21/442; H04N 21/443; H04N 21/4784; H04N 21/485

(52) U.S. Cl. CPC G06Q 30/0207; H04N 21/44204; H04N 21/4436; H04N 21/4784; H04N 21/485

(57) ABSTRACT

An electronic device includes: a display; memory storing instructions, and image quality processing information for each of a plurality of power consumption reduction levels; and at least one processor operatively connected with the display and the memory, wherein the at least one processor is configured to execute the instructions to: identify a power consumption reduction amount corresponding to a selected level among the plurality of power consumption reduction levels based on the image quality processing information, identify a user reward based on the identified power consumption reduction amount, and control the display to display information about the identified user reward.

### CROSS-REFERENCE TO RELATED APPLICATION(S)

This application is a continuation of International Application No. PCT/KR2023/011424, filed on Aug. 3, 2023, in the Korean Intellectual Property Receiving Office, which is based on and claims priority to Korean Patent Application No. 10-2022-0119966, filed on Sep. 22, 2022, in the Korean Intellectual Property Office, the disclosures of which are incorporated by reference herein in their entireties.

### BACKGROUND

### 1. Field

The disclosure relates to an electronic device and a control method thereof, and more particularly, to an electronic device that provides a power consumption reduction mode that can be selected by a user, and a method for reducing power consumption thereof.

### 2. Description of Related Art

Spurred by the development of electronic technologies, various types of electronic devices are being developed and distributed. In particular, distribution of display devices such as a TV or a smartphone is actively going on.

Among technologies for power consumption reduction of conventional displays, a technology that enables achievement of efficiency of power consumption, and at the same time, may prevent a glare phenomenon when watching a screen of a bright display in a dark environment, by interlocking a display device and an illumination sensor, and when a viewing environment is dark, reducing the brightness of the display, and when a viewing environment is bright, improving the brightness of the display exists. As another technology, a technology that makes a screen of a display dark or turns off the screen in case an input of the user of the display is not input during a specific time period or longer exists.

### SUMMARY

Aspects will be set forth in part in the description which follows and, in part, will be apparent from the description, or may be learned by practice of the presented embodiments.

According to an aspect of the disclosure, an electronic device may include: a display; memory storing instructions, and image quality processing information for each of a plurality of power consumption reduction levels; and at least one processor operatively connected with the display and the memory, wherein the at least one processor is configured to execute the instructions to: identify a power consumption reduction amount corresponding to a selected level among the plurality of power consumption reduction levels based on the image quality processing information, identify a user reward based on the identified power consumption reduction amount, and control the display to display information about the identified user reward.

The at least one processor may be further configured to execute the instructions to: provide a user interface (“UI”) for selecting the selected level among the plurality of power consumption reduction levels through the display, identify a plurality of image quality elements corresponding to the selected level based on the image quality processing information, identify power consumption reduction amounts corresponding to the plurality of image quality elements, and identify a final power consumption reduction amount by combining the identified power consumption reduction amounts.

The at least one processor may be further configured to execute the instructions to: based on a viewing time being equal to or greater than a predetermined reference viewing time, provide a user reward based on a power consumption reduction amount corresponding to the predetermined reference viewing time and a UI for selecting a compensation method of the user reward through the display, and based on a compensation method of the user reward being selected through the UI, process the user reward according to the selected compensation method.

The at least one processor may be further configured to execute the instructions to: based on the user reward being processed, provide a feedback UI for selecting at least one of whether to maintain or change the selected level through the display, and re-execute a power consumption reduction mode according to a user instruction received through the feedback UI.

The image quality processing information may include: control information corresponding to each power consumption reduction level for a plurality of image quality processing elements, where the plurality of image quality processing elements include: at least one of driving processing, contrast ratio processing, motion processing, noise processing, sharpness processing, or color processing.

The at least one processor may be further configured to execute the instructions to: identify power consumption reduction amounts for each hour of viewing time based on the control information for each image quality processing element corresponding to the selected level, identify a final power consumption reduction amount based on the power consumption reduction amounts for each hour of viewing time and the predetermined reference viewing time, and determine a predicted value of additional information according to the final power consumption reduction amount as the user reward.

The additional information may include: at least one of an effect of reduction of an electric bill, an effect of reduction of carbon, or an effect of planting trees.

The at least one processor may be further configured to execute the instructions to: based on the viewing time being equal to or greater than the predetermined reference viewing time, control the display to provide a UI including information on the predicted value of the additional information and the user reward.

The at least one processor may be further configured to execute the instructions to: control the display to provide a UI for using the user reward for at least one service provided from a third party, where the at least one service includes: at least one of a product purchase service, a subscription purchase service, or a donation service.

The at least one processor may be further configured to execute the instructions to: based on a power consumption reduction mode being turned on, automatically activate a lowest level among the plurality of power consumption reduction levels, and based on a level among the plurality of power consumption reduction levels being selected, identify image quality processing information corresponding to the selected level.

According to an aspect of the disclosure, provided is a method for reducing power consumption of an electronic device, the method may include: identifying a power consumption reduction amount corresponding a selected level among a plurality of power consumption reduction levels based on image quality processing information; identifying a user reward based on the identified power consumption reduction amount; and displaying information about the identified user reward.

The identifying the power consumption reduction amount may include: providing a user interface (“UI”) for selecting the selected level among the plurality of power consumption reduction levels through the display; identifying a plurality of image quality elements corresponding to the selected level based on the image quality processing information; identifying power consumption reduction amounts corresponding to the plurality of image quality elements; and identifying a final power consumption reduction amount by combining the identified power consumption reduction amounts.

The method may further include: based on a viewing time being equal to or greater than a predetermined reference viewing time, providing a user reward based on a power consumption reduction amount corresponding to the reference viewing time and a UI for selecting a compensation method of the user reward; and based on a compensation method of the user reward being selected through the UI, processing the user reward according to the selected compensation method.

The method may further include: based on the user reward being processed, providing a feedback UI for selecting at least one of whether to maintain or change the selected level; and re-executing a power consumption reduction mode according to a user instruction received through the feedback UI.

According to an aspect of the disclosure, provided is a non-transitory computer readable medium storing computer instructions which, when executed by at least one processor of an electronic device, cause the electronic device to perform operations, the operations may include: identifying a power consumption reduction amount corresponding to a selected level among a plurality of power consumption reduction levels based on image quality processing information; identifying a user reward based on the identified power consumption reduction amount; and displaying information about the identified user reward.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for illustrating an implementation example of an electronic device according to an embodiment;

FIG. 2A is a block diagram illustrating a configuration of an electronic device according to an embodiment;

FIG. 2B is a block diagram illustrating in detail a configuration of an electronic device according to an embodiment;

FIG. 2C is a diagram for illustrating a module used in a power consumption reducing technology according to an embodiment;

FIG. 3 is a diagram for illustrating a method of providing a power consumption reduction mode according to an embodiment;

FIG. 4 is a diagram for illustrating operations of image quality processing elements according to power consumption levels according to an embodiment;

FIG. 5A and FIG. 5B are diagrams illustrating a user interface (“UI”) according to an embodiment;

FIG. 6A and FIG. 6B are diagrams illustrating a UI according to an embodiment;

FIG. 7A, FIG. 7B, FIG. 8A, and FIG. 8B are diagrams illustrating a UI according to an embodiment;

FIG. 9A, FIG. 9B, FIG. 10A, and FIG. 10B are diagrams illustrating a UI according to an embodiment; and

FIG. 11 is a diagram for illustrating a method of implementing an ESG mode according to an embodiment.

### DETAILED DESCRIPTION

Hereinafter, example embodiments of the disclosure will be described in detail with reference to the accompanying drawings.

First, terms used in this specification will be described briefly, and then the disclosure will be described in detail.

As terms used in the embodiments of the disclosure, general terms that are currently used widely were selected as far as possible, in consideration of the functions described in the disclosure. However, the terms may vary depending on the intention of those skilled in the art, previous court decisions, or emergence of new technologies, etc. Also, in particular cases, there may be terms that were arbitrarily designated by the applicant, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g., elements such as numbers, functions, operations, and components), and do not exclude the existence of additional characteristics.

In addition, the expression “at least one of A and/or B” should be interpreted to mean any one of “A” or “B” or “A and B.”

Further, the expressions “first,” “second” and the like used in this specification may be used to describe various elements regardless of any order and/or degree of importance. Also, such expressions are used only to distinguish one element from another element, and are not intended to limit the elements.

Meanwhile, the description in the disclosure that one element (e.g., a first element) is “(operatively or communicatively) coupled with/to” or “connected to” another element (e.g., a second element) should be interpreted to include both the case where the one element is directly coupled to the another element, and the case where the one element is coupled to the another element through still another element (e.g., a third element).

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that a device is “specifically designed to” in terms of hardware.

In addition, singular expressions include plural expressions, unless defined obviously differently in the context. Also, in the disclosure, terms such as “comprise,” “have,” “include” “consist of,” and variations thereof should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Further, in the disclosure, “a module” or “a part” performs at least one function or operation, and may be implemented as hardware or software, or as a combination of hardware and software. In addition, a plurality of “modules” or “parts” may be integrated into at least one module and implemented as at least one processor, except “a module” or “a part” that needs to be implemented as specific hardware.

Hereinafter, an embodiment of the disclosure will be described in more detail with reference to the accompanying drawings.

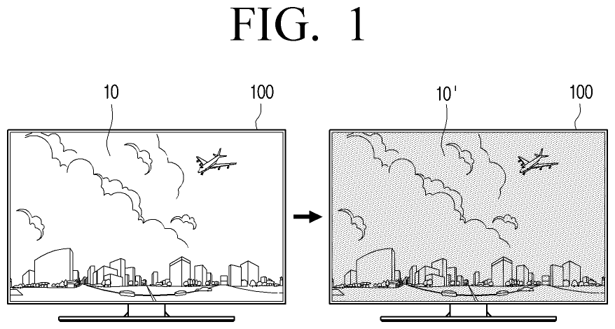

FIG. 1 is a diagram for illustrating an implementation example of an electronic device according to an embodiment.

The electronic device 100 may be implemented as a TV, but is not limited thereto, and any device equipped with a display function such as a video wall, a large format display (LFD), digital signage, a digital information display (DID), a projector display, a smartphone, a tablet PC, a laptop PC, a head mounted display (HMD), a near eye display (NED), an electronic photo frame, a camera, a camcorder, etc. can be applied without limitation.

According to an embodiment, the electronic device 100 may receive various compressed images or images of various resolutions. For example, the electronic device 100 may receive images in compressed forms such as moving picture experts group (MPEG) (e.g., MP2, MP4, MP7, etc.), joint photographic coding experts group (JPEG), advanced video coding (AVC), H.264, H.265, high efficiency video codec (HEVC), etc. Alternatively, the electronic device 100 may receive any one image among standard definition (SD), high definition (HD), full HD, and ultra HD images.

According to an embodiment, the electronic device 100 obtains an output image by performing image processing of an input image. Here, an input image and an output image may be standard definition (SD), high definition (HD), full HD, ultra high definition (UHD) images, etc. In particular, an output image may be an ultra high definition (UHD) image, e.g., a 4K image (3840×2160) image or an image having a resolution of 8K (7680×4320) or bigger (e.g., 16K, 32K), but is not limited thereto. Image processing may be digital image processing including at least one of image enhancement, image restoration, image transformation, image analysis, image understanding, or image compression. According to an embodiment, image improvement processing may include at least one of driving processing, contrast ratio processing, motion processing, noise processing, sharpness processing, or color processing. For example, image improvement processing may be processed by using a trained artificial intelligence model and various image quality processing algorithms.

According to an embodiment, the electronic device 100 may obtain an output image 10′ by providing a plurality of power consumption reduction levels, and applying image processing corresponding to a level selected by the user to an image 10. In this case, the electronic device 100 may, through provision of compensation by the manufacturer for a power saving effect corresponding to the selected level, give motivation for use of a power saving mode to the user, and induce the consumer to ultimately contribute to Environment, Social & Governance (ESG). In this sense, a power consumption reduction mode will also be referred to as an ESG mode (or an ESG technology). However, the term can obviously be replaced by another term.

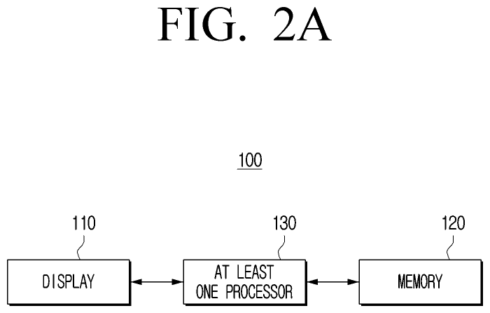

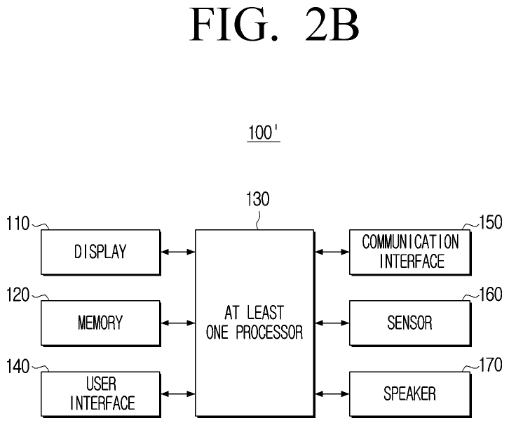

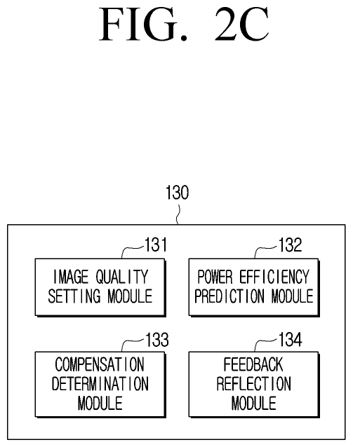

FIG. 2A is a block diagram illustrating a configuration of an electronic device according to an embodiment.

According to FIG. 2A, the electronic device 100 includes a display 110, memory 120, and at least one processor 130.

The display 110 may be implemented as a display including self-luminous elements, or a display including non-self-luminous elements and a backlight. For example, the display 110 may be implemented as displays in various forms such as a liquid crystal display (LCD), an organic light emitting diodes (OLED) display, light emitting diodes (LEDs), micro LEDs, mini LEDs, a plasma display panel (PDP), a quantum dot (QD) display, quantum dot light emitting diodes (QLEDs), etc. Inside the display 110, driving circuits that may be implemented in forms such as an a-si TFT, a low temperature poly silicon (LTPS) TFT, an organic TFT (OTFT), etc., and a backlight unit, etc. may also be included together. According to an embodiment, on the front surface of the display 110, a touch sensor that has a form such as a touch film, a touch sheet, a touch pad, etc. and detects a touch operation may be arranged and implemented to detect various types of touch inputs. For example, the display 110 may detect various types of touch inputs such as a touch input by a user's hand, a touch input by an input device such as a stylus pen, a touch input by a specific electrostatic material, etc. Here, the input device may be implemented as an input device in a pen type that can be referred to as various terms such as an electronic pen, a stylus pen, an S-pen, etc. According to an embodiment, the display 110 may be implemented as a flexible display that can be folded and/or rolled.

The memory 120 may store data necessary for various embodiments. The memory 120 may be implemented in a form of memory embedded in the electronic device 100, or implemented in a form of memory that can be attached to or detached from the electronic device 100 according to the usage of stored data. For example, in the case of data for operating the electronic device 100, the data may be stored in memory embedded in the electronic device 100, and in the case of data for an extended function of the electronic device 100, the data may be stored in memory that can be attached to or detached from the electronic device 100. Meanwhile, in the case of memory embedded in the electronic device 100, the memory may be implemented as at least one of volatile memory (e.g., dynamic RAM (DRAM), static RAM (SRAM), or synchronous dynamic RAM (SDRAM), etc.) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, etc.), a hard drive, or a solid state drive (SSD)). Also, in the case of memory that can be attached to or detached from the electronic device 100, the memory may be implemented in forms such as a memory card (e.g., compact flash (CF), secure digital (SD), micro secure digital (Micro-SD), mini secure digital (Mini-SD), extreme digital (xD), a multi-media card (MMC), etc.), and external memory that can be connected to a USB port (e.g., a USB memory), etc.

According to an embodiment, the memory 120 may store image quality processing information for each of a plurality of power consumption reduction levels. For example, the image quality processing information for each of the plurality of power consumption reduction levels may include control information corresponding to each level for each of a plurality of image quality processing elements. Here, the plurality of image quality processing elements may include at least one of driving processing, contrast ratio processing, motion processing, noise processing, sharpness processing, or color processing.

According to an embodiment, the memory 120 may store information on an artificial intelligence model including a plurality of layers for image quality processing, e.g., image quality improvement processing. Here, the feature of storing information on an artificial intelligence model may mean storing various kinds of information related to operations of the artificial intelligence model, e.g., information on the plurality of layers included in the artificial intelligence model, information on parameters used in each of the plurality of layers (e.g., filter coefficients, biases, etc.). For example, according to an embodiment, the memory 112010 may store information on an artificial intelligence model that was trained to obtain upscaling information of an input image.

The at least one processor 130 controls the overall operations of the electronic device 100. Specifically, the at least one processor 130 may be connected with each component of the electronic device 100, and control the overall operations of the electronic device 100. For example, the at least one processor 130 may be electrically connected with the display 110 and the memory 120 and control the overall operations of the electronic device 100. The processor 130 may consist of one or a plurality of processors.

The at least one processor 130 may perform the operations of the electronic device 100 according to various embodiments by executing the at least one instruction stored in the memory 120.

The at least one processor 130 may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The at least one processor 130 may control one or a random combination of the other components of the electronic device, and perform an operation related to communication or data processing. Also, the at least one processor 130 may execute one or more programs or instructions stored in the memory. For example, the at least one processor 130 may perform the method according to an embodiment of the disclosure by executing the at least one instruction stored in the memory.

In case the method according to an embodiment of the disclosure includes a plurality of operations, the plurality of operations may be performed by one processor, or performed by a plurality of processors. For example, when a first operation, a second operation, and a third operation are performed by the method according to an embodiment, all of the first operation, the second operation, and the third operation may be performed by a first processor, or the first operation and the second operation may be performed by the first processor (e.g., a generic-purpose processor), and the third operation may be performed by a second processor (e.g., an artificial intelligence-dedicated processor).

The at least one processor 130 may be implemented as a single core processor including one core, or it may be implemented as one or more multicore processors including a plurality of cores (e.g., multicores of the same kind or multicores of different kinds). In case the at least one processor 130 is implemented as multicore processors, each of the plurality of cores included in the multicore processors may include internal memory of the processor such as cache memory, on-chip memory, etc., and a common cache shared by the plurality of cores may be included in the multicore processors. Also, each of the plurality of cores (or some of the plurality of cores) included in the multicore processors may independently read a program instruction for implementing the method according to an embodiment of the disclosure and perform the instruction, or the plurality of entire cores (or some of the cores) may be linked with one another, and read a program instruction for implementing the method according to an embodiment of the disclosure and perform the instruction.

In case the method according to an embodiment of the disclosure includes a plurality of operations, the plurality of operations may be performed by one core among the plurality of cores included in the multicore processors, or they may be performed by the plurality of cores. For example, when the first operation, the second operation, and the third operation are performed by the method according to an embodiment, all of the first operation, the second operation, and the third operation may be performed by a first core included in the multicore processors, or the first operation and the second operation may be performed by the first core included in the multicore processors, and the third operation may be performed by a second core included in the multicore processors.

In the embodiments of the disclosure, the processor may mean a system on chip (SoC) wherein at least one processor and other electronic components are integrated, a single core processor, a multicore processor, or a core included in the single core processor or the multicore processor. Also, here, the core may be implemented as a CPU, a GPU, an APU, a MIC, a DSP, an NPU, a hardware accelerator, or a machine learning accelerator, etc., but the embodiments of the disclosure are not limited thereto. Hereinafter, the at least one processor 130 will be referred to as the processor 130, for the convenience of explanation.

FIG. 2B is a block diagram illustrating in detail a configuration of an electronic device according to an embodiment.

According to FIG. 2B, the electronic device 100′ may include a display 110, memory 120, at least one processor 130, a user interface 140, a communication interface 150, a sensor 160, and a speaker 170. Among the components illustrated in FIG. 2B, regarding components overlapping with the components illustrated in FIG. 2A, detailed explanation will be omitted.

The user interface 140 may be implemented as a device such as a button, a touch pad, a mouse, and a keyboard, or may be implemented as a touch screen that can perform the aforementioned display function and a manipulation input function together, etc. According to an embodiment, the user interface 140 may be implemented as a remote control transceiver, and receive a remote control signal. The remote control transceiver may receive a remote control signal, or transmit a remote control signal from an external remote control device through at least one communication method among infrared communication, Bluetooth communication, or Wi-Fi communication.

The communication interface 150 can obviously be implemented as various interfaces depending on implementation examples of the electronic device 100′. For example, the communication interface 150 may perform communication with an external device, an external storage medium (e.g., a USB memory), an external server (e.g., a webhard), etc. through communication methods such as Bluetooth, AP-based Wi-Fi (Wi-Fi, a wireless LAN network), Zigbee, a wired/wireless local area network (LAN), a wide area network (WAN), an Ethernet, the IEEE 1394, a high-definition multimedia interface (HDMI), a universal serial bus (USB), a mobile high-definition link (MHL), the Audio Engineering Society/European Broadcasting Union (AES/EBU), Optical, Coaxial, etc.

The sensor 160 senses an external light. Specifically, the sensor 160 may detect at least one among various characteristics such as the illumination, the strength, the color, the incident direction, the incident area, the distribution, etc. of a light. Depending on implementation examples, the sensor 160 may be an illumination sensor, a temperature detection sensor, a light amount sensing layer, a camera, etc. In particular, the sensor 160 may be implemented as an illumination sensor that senses RGB lights, but is not limited thereto, and any device that can sense lights such as a white sensor, an IR sensor, an IR+RED sensor, an HRM sensor, a camera, etc. can be applied. Meanwhile, at least one sensor 160 may be provided, and in case a plurality of sensors 160 are provided, any location wherein illumination in different directions can be measured can be applied.

Other than the above, the sensor 160 may further include various types of sensors such as a touch sensor, a proximity sensor, an acceleration sensor, a geomagnetic sensor, a gyro sensor, a pressure sensor, a position sensor, etc.

The speaker 170 may be a component that outputs not only various types of audio data, but also various types of notification sounds or voice messages, etc. The processor 130 may control the speaker 170 to output information or various types of notifications corresponding to UI screens according to the various embodiments of the disclosure in audio forms.

The electronic device 100′ may additionally include a speaker, a tuner, and a demodulator depending on implementation examples. The tuner may tune a channel selected by a user in a radio frequency (RF) broadcast signal received through an antenna, or all pre-stored channels, and receive an RF broadcast signal. The demodulator may receive a digital IF (DIF) signal converted at the tuner and demodulate the signal, and perform channel demodulation, etc.

Other than the above, the electronic device 100′ may further include a camera, a microphone, etc. depending on implementation examples.

The camera may be turned on according to a predetermined event and perform photographing. The camera may convert a photographed image into an electric signal, and generate image data based on the converted signal. For example, a subject may be converted into an electric image signal through a semiconductor charge coupled device (CCD), and the image signal converted as such may be amplified and converted into a digital signal, and then go through signal processing.

The microphone is a component for receiving inputs of a user voice or other sounds, and converting them into audio data. However, according to another embodiment, the electronic device 100′ may receive a user voice input through an external device through the communication interface 150.

According to an embodiment, the electronic device 100 may provide a platform (referred to as an ESG platform hereinafter) by which a user can select a power consumption reduction level and can be compensated with a user reward according to the power saving effect from the manufacturer and can use the reward. In the aspect that both of the manufacturer and a user contribute to the environment by cooperating with each other, a power consumption reduction mode according to the disclosure will be referred to as an ESG mode, and a power consumption reduction level according to the disclosure will be referred to as an ESG level. However, it is obvious to a person skilled in the art that these are merely terms used for the convenience of explanation, while emphasizing the meaning of the disclosure.

Control of the ESG mode and management of a user reward according to an embodiment may be implemented in various forms depending on implementation examples of the electronic device 100. For example, in case the electronic device 100 is implemented as a TV, a UI and functions for control of the ESG mode and management of a user reward may be provided through an OSD menu and/or an application. For example, in case the electronic device 100 is implemented as a smartphone, a UI and functions for control of the ESG mode and management of a user reward may be provided through an application. For example, an application of a smartphone and a TV menu may be interlocked through communication such as Wi-Fi or Bluetooth and operated.

FIG. 2C is a diagram for illustrating a module used in a power consumption reducing technology according to an embodiment.

According to FIG. 2C, the processor 130 may control a power consumption reduction technology by using an image quality setting module 131, a power efficiency prediction module 132, a compensation determination module 133, and a feedback reflection module 134. Here, each module may be implemented as at least one software, at least one hardware, and/or a combination thereof.

According to an embodiment, the processor 130 may identify an image quality processing level corresponding to a level selected by the user among a plurality of power consumption reduction levels by using the image quality setting module 131.

According to an embodiment, the processor 130 may predict a power reduction amount corresponding to an image quality processing level identified through the image quality setting module 131 by using the power efficiency prediction module 132.

According to an embodiment, the processor 130 may identify a user reward corresponding to a power reduction amount predicted through the power efficiency prediction module 132 by using the compensation determination module 133, and process the user reward according to a compensation method determined by the user.

According to an embodiment, the processor 130 may manage maintenance/stopping of the power consumption reduction mode, maintenance/reinforcement of a power consumption reduction level, etc. by reflecting a user feedback for the power consumption reduction mode by using the feedback reflection module 134.

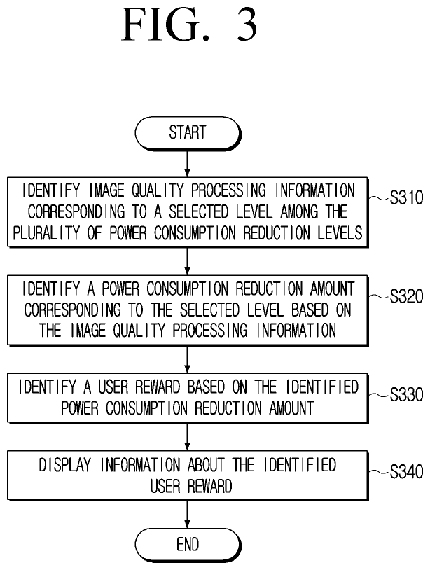

FIG. 3 is a diagram for illustrating a method of providing a power consumption reduction mode according to an embodiment.

According to an embodiment illustrated in FIG. 3, the processor 130 may identify image quality processing information corresponding to a selected level among the plurality of power consumption reduction levels (referred to as ESG levels for the convenience of explanation hereinafter) in the step S310. According to an embodiment, the processor 130 may identify image quality processing information corresponding to a selected level by using the image quality setting module 131 illustrated in FIG. 2C.

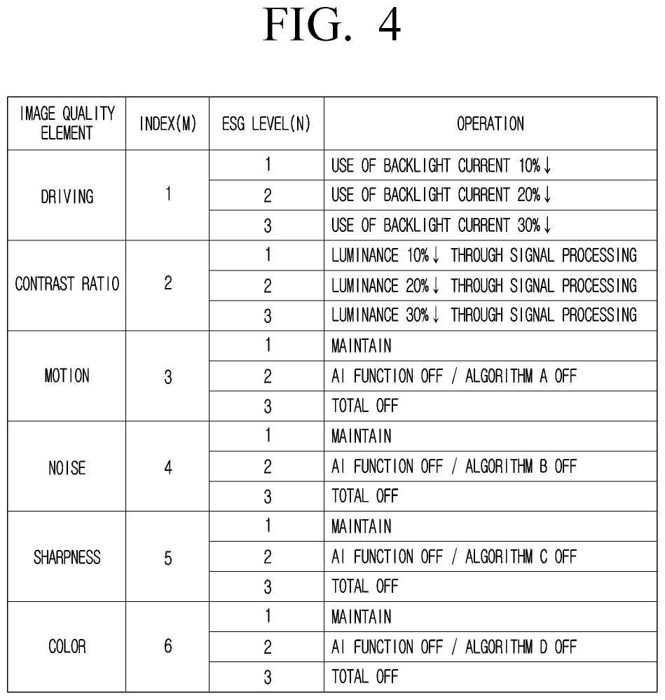

For example, the processor 130 may identify image quality processing information corresponding to a selected level based on information stored in the memory 120. According to an embodiment, the information stored in the memory 120 may be in a form as illustrated in FIG. 4. For example, as illustrated in FIG. 4, control information corresponding to index values for each image quality processing element (or image quality element), and image quality processing operations according to each ESG level may be stored in a form of a table. Here, each image quality processing element may include at least one of driving processing, contrast ratio processing, motion processing, noise processing, sharpness processing, or color processing. According to an embodiment, as illustrated in FIG. 4, a case wherein the ESG levels are divided into level 1, level 2, and level 3, and a power reduction rate is higher as the number is higher will be assumed. However, this is merely an example, and the ESG levels can obviously be further subdivided or further simplified.

In this case, control information corresponding to image quality processing operations corresponding to each of the level 1, level 2, and level 3 for each image quality processing element may be stored in a table form. For example, as illustrated in FIG. 4, the control information may be stored in a form like an index value corresponding to driving processing is 1, and control information corresponding to the level 1 is “use of the backlight current down by 10%,” and control information corresponding to the level 2 is “use of the backlight current down by 20%,” and control information corresponding to the level 3 is “use of the backlight current down by 30%.” However, this is merely an example, and image quality processing methods for each image quality processing element according to the ESG levels can also be set in various ways. For example, the image quality processing methods can be set in various ways according to the manufacturers in consideration of an image quality setting method according to an improvement rate of the entire power consumption or an image quality setting method according to a reduction amount of the designated image quality performance, etc.

For example, in case the level 2 was selected among the level 1, level 2, and level 3, the processor 130 may identify control information for each image quality processing element corresponding to the level 2. For example, control information which is that driving processing is “use of the backlight current down by 20%,” contrast ratio processing is “luminance down by 20% through signal processing,” motion processing is “AI function OFF/algorithm A OFF,” noise processing is “AI function OFF/algorithm B OFF,” sharpness processing is “AI function OFF/algorithm C OFF,” and color processing is “AI function OFF/algorithm D OFF” may be identified.

According to an embodiment, the processor 130 may perform each image quality processing by using a video processing unit (VPU) in the SoC provided in the display 110.

Then, the processor 130 may identify (or predict) a power consumption reduction amount corresponding to the identified image quality processing information in the step S320. According to an embodiment, the processor 130 may identify power consumption reduction amounts for each hour based on control information of each image quality processing element corresponding to a selected level by using the power efficiency prediction module 132 illustrated in FIG. 2C, and identify a final power consumption reduction amount based on the power consumption reduction amounts for each hour and a reference viewing time. However, depending on cases, it is possible to calculate a final power consumption reduction amount corresponding to a viewing time selected by the user.

For example, the processor 130 may measure in advance the power reduction amounts for each hour PowerSaving[m][n](W/h) according to ON/OFF of operations according to the ESG levels for each image quality element illustrated in FIG. 4. For example, as a test image for measurement, a conventional reference image for power consumption measurement or test images individually manufactured by each manufacturer may be utilized.

For example, in the case of having reproduced a test image through the display 110, and having turned on and turned off operations for each image quality processing element (m), power consumption consumed in hardware included in the SoC of the display 110, e.g., a video processing unit (VPU), a neural processing unit (NPU), a graphics processing unit (GPU), a central processing unit (CPU), etc. may be calculated, and then the differences in the power consumption in each case may be calculated, and the differences may be converted into W/h.

Then, the processor 130 may sum up the PowerSaving [m] [n] (W/h) corresponding to the same level of each image quality element, and calculate an average power consumption reduction amount for each hour for each ESG level TotalPowerSavingₗₑᵥₑₗ₌ₙ=Σₘ PowerSaving[m][n](W/h). Then, in case the user uses the ESG mode during a T time according to a reference viewing time T(h) set in advance by the manufacturer, the processor 130 may calculate the final power consumption reduction amount T*Pₗₑᵥₑₗ₌ₙ=TotalPowerSavingₗₑᵥₑₗ₌ₙ. The P values for each ESG level calculated as such may be stored as data in a form of a look-up table. The processor 130 may identify a predicted power consumption reduction amount according to change of the ESG level based on such data. According to an embodiment, in case the P values for each ESG level were stored in the memory 120 as data in a form of a look-up table, it may be possible that the table in FIG. 4 is not stored in the memory 120.

Then, the processor 130 may identify a user reward based on the final power consumption reduction amount in the step S330. According to an embodiment, the processor 130 may convert a predicted value of additional information according to the final power consumption reduction amount into a user reward by using the compensation determination module 133 illustrated in FIG. 2C. Here, the additional information may include at least one of an effect of reduction of an electric bill, an effect of reduction of carbon, or an effect of planting trees.

According to an embodiment, predicted values according to each type of additional information may respectively be calculated, or predicted values according to types of additional information selected by the user and/or the manufacturer may be calculated. For example, the processor 130 may calculate predicted values of additional information such as a reduction amount of an electric bill, a reduction amount of carbon, an effect of planting 00 trees, etc. according to the final power consumption reduction amount corresponding to an ESG level selected by the user. The processor 130 may convert a predicted value of additional information into a user reward, e.g., an ESG point. For example, the processor 130 may calculate predicted values of additional information such as a reduction amount of carbon, an effect of planting 00 trees, etc. by using a convention formula calculating an emission amount of carbon dioxide from a power consumption reduction amount.

According to an embodiment, methods of calculating a reward may vary according to the specification of the electronic device 100 and/or the image quality setting methods for each ESG level. For example, in case the size of the display 110 of the electronic device 100 is relatively big and the maximum brightness is relatively big (e.g., a high end TV), the range of a reward may be relatively broader compared to a device which does not fall under such a case. That is, in the case of a high end TV, a reward corresponding to the highest level may be relatively bigger compared to another device. However, as methods of calculating a reward may be determined as various methods by manufacturers, it is obvious that a reward can be calculated in the same range even for devices having different specifications.

Afterwards, the processor 130 may display information on the identified user reward through the display 110 in the step S340. For example, if the reference viewing time set in advance by the manufacturer passes, the processor 130 may provide a UI including information on the predicted values of additional information and the user reward. For example, if a compensation method for the user reward is selected through the UI, the processor 130 may process the user reward according to the selected compensation method.

According to an embodiment, when the power consumption reduction mode is turned on, the processor 130 may automatically activate (or execute) the lowest level among the plurality of power consumption reduction levels. Afterwards, the processor 130 may execute the power consumption reduction mode according to a level selected according to a user instruction.

According to an embodiment, after the user reward is processed according to the compensation method selected by the user, the processor 130 may update the currently executed ESG mode by reflecting the user's feedback. According to an embodiment, the processor 130 may determine at least one of whether to maintain the currently executed ESG mode, whether to maintain the currently executed level, or whether to reinforce the currently executed level by using the feedback reflection module 134 illustrated in FIG. 2C.

For example, the processor 130 may provide a UI that can receive a user feedback regarding whether to maintain or stop the ESG mode and whether to maintain or change (e.g., reinforce or weaken) the ESG level, and turn off the ESG mode, or maintain or reinforce (or weaken) the ESG level according to the user feedback.

Meanwhile, according to an embodiment, the processor 130 may provide various types of UIs for control of the ESG mode and/or management of a user reward in forms of a pop-up and/or an OSD through the display 110. Depending on implementation examples of the electronic device 100, a UI may be provided through an OSD menu, an application menu, etc. For example, in case the electronic device 100 is implemented as a TV, the aforementioned UI for control of the ESG mode and management of a user reward may be provided through an OSD menu and/or an application. For example, in case the electronic device 100 is implemented as a smartphone, the UI for control of the ESG mode and management of a user reward may be provided through an application. For example, an application of a smartphone and a TV menu may be interlocked and operated.

For example, the processor 130 may provide at least one of a UI for selecting whether to activate (or ON/OFF) the ESG mode, a UI for selecting an ESG level, a UI for selecting whether to activate (or ON/OFF) a reward mode, a UI for selecting a compensation method of a user reward, or a feedback UI for selecting whether to maintain and/or reinforce the selected level through the display 110.

The aforementioned UIs may respectively be provided individually, or at least some UIs may be integrated and provided as one UI. For example, a UI for selecting whether to activate the ESG mode, a UI for selecting an ESG level, and a UI for selecting whether to activate a reward mode may be provided as one UI. As another example, a UI for selecting whether to activate the ESG mode, a UI for selecting an ESG level, and a UI for selecting whether to activate a reward mode may respectively be provided sequentially as individual UIs.

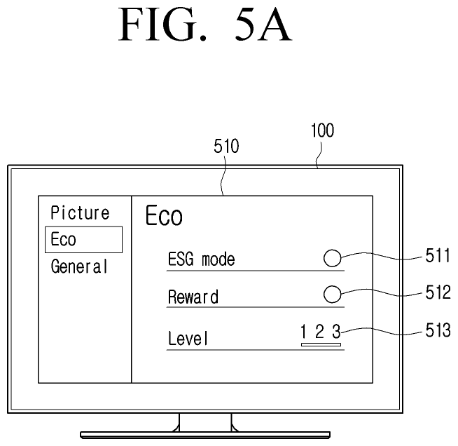

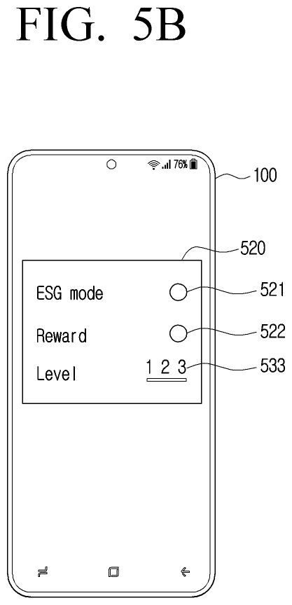

FIG. 5A and FIG. 5B are diagrams illustrating a UI according to an embodiment.

FIG. 5A and FIG. 5B indicate a case wherein a UI for selecting whether to activate the ESG mode, a UI for selecting an ESG level, and a UI for selecting whether to activate a reward mode are merged as one UI and provided according to an embodiment.

FIG. 5A is a diagram illustrating a form of a UI that is provided in case the electronic device 100 is implemented as a TV according to an embodiment. As illustrated in FIG. 5A, the UI 510 may include a menu 511 for selecting whether to activate the ESG mode, a menu 512 for selecting whether to activate a reward mode, and a menu 513 for selecting an ESG level. For example, the user may select each menu 511, 512, 513 through a remote control device. However, the UI illustrated in FIG. 5A is merely an example, and the same information can obviously be implemented in a different design. For example, the electronic device 100 may be implemented such that an ON button corresponding to activation of the ESG mode and an OFF button corresponding to inactivation are displayed, and the user selects one of the two buttons.

FIG. 5B is a diagram illustrating a form of a UI that is provided in case the electronic device 100 is implemented as a smartphone according to an embodiment. As illustrated in FIG. 5B, the UI 520 may include menus 521, 522, 523 in similar forms to those in FIG. 5A. For example, the user may select each menu 521, 522, 523 through a touch input. However, this is merely an example, and the same information can obviously be implemented in a different design. For example, the processor 130 may provide a UI in a form of a slide button for selecting whether to activate the ESG mode.

When the ESG mode and an ESG level, and reward compensation are selected through the UIs as illustrated in FIG. 5A and FIG. 5B, the selected ESG level may be maintained during the predetermined reference viewing time and the power consumption reduction amount may be calculated, and a reward value that the user will get may be determined.

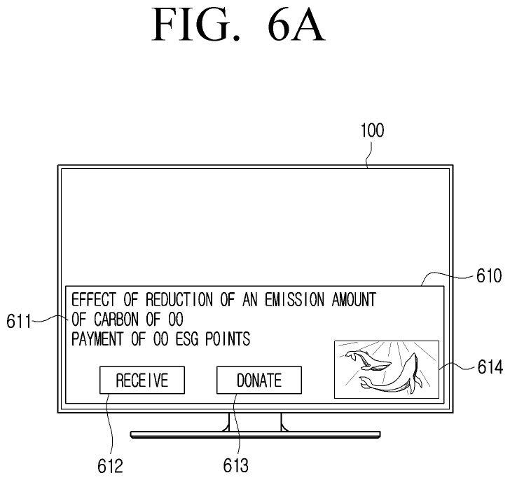

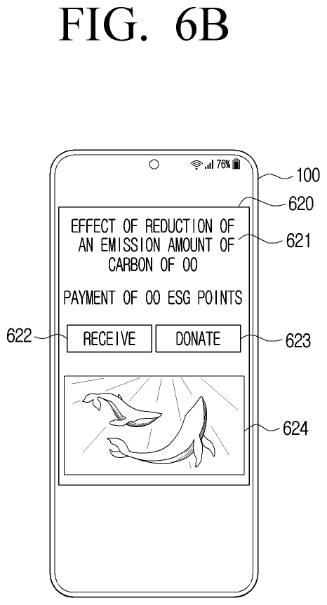

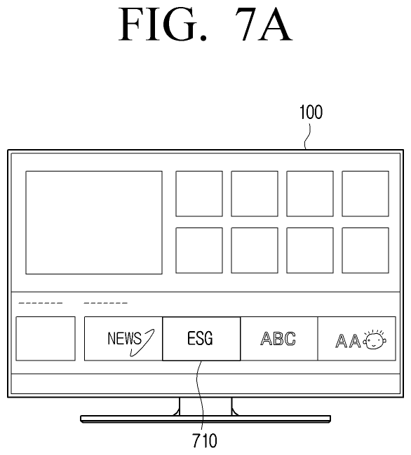

FIG. 6A and FIG. 6B are diagrams illustrating a UI according to an embodiment.

FIG. 6A and FIG. 6B illustrate a UI for selecting a compensation method of a user reward according to an embodiment. According to an embodiment, a UI may include a predicted value of additional information according to a reward, the amount of ESG points that were paid up to now, a menu for selecting a compensation method, etc. The additional information may include at least one of an effect of reduction of an electric bill, an effect of reduction of carbon, or an effect of planting trees, but hereinafter, explanation will be described by assuming a case wherein the additional information is an effect of reduction of carbon. For example, the UI illustrated in FIG. 6A and FIG. 6B may be provided in case the predetermined reference viewing time (e.g., one month) passed, but is not limited thereto.

FIG. 6A is a diagram illustrating a form of a UI that is provided in case the electronic device 100 is implemented as a TV according to an embodiment. As illustrated in FIG. 6A, the UI 610 may include information indicating a predicted value of additional information according to a reward and the amount of ESG points that were paid up to now such as an effect of reduction of an emission amount of carbon by 00 and payment of 00 ESG points 611 up to now. Also, the UI 610 may include menu buttons 612, 613 for selecting a compensation method. For example, the user may select the menu buttons 612, 613 that can be selected through a remote control device. However, the UI illustrated in FIG. 6A is merely an example, and the same information can obviously be implemented in a different design.

FIG. 6B is a diagram illustrating a form of a UI that is provided in case the electronic device 100 is implemented as a smartphone according to an embodiment. As illustrated in FIG. 6B, the UI 620 may include menu buttons 621, 622, 623 in similar forms to those in FIG. 6A. For example, the user may select the menu buttons 622, 623 that can be selected through a touch input. However, this is merely an example, and the same information can obviously be implemented in a different design.

For example, the user may receive a reward by a point method and use it through an account interlocked with the electronic device 100 later, or contribute it to an environment group, etc. under the user's name through donation. Compensation methods can be implemented in various ways according to the manufacturers other than the above. However, in case the reward mode was not selected (i.e., in case the reward mode is OFF), this process may be omitted.

According to an embodiment, the UIs 610, 620 may include exposure type advertisements 614, 624. Also, according to an embodiment, an exposure type advertisement may be an advertisement by a third party that pays an advertising fee to the company (e.g., the manufacturer) providing an ESG platform. For example, the company providing an ESG platform may pay ESG points to the user by utilizing advertising revenues. Advertisements may be in various forms, but as an example, an advertisement of a content related to ESG such as an environment documentary may be provided by affiliating with an OTT company such as Netflix, and when the user selects this, the user may be made to immediately access the content in the OTT platform. Also, when the user selects a donation button 613, 623, money corresponding to the ESG points that the user can receive may be donated to an environment group affiliated with the company providing the ESG mode platform, etc.

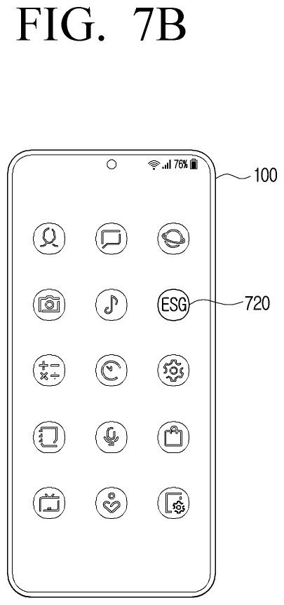

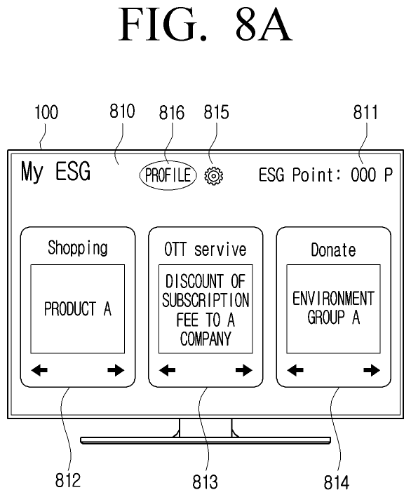

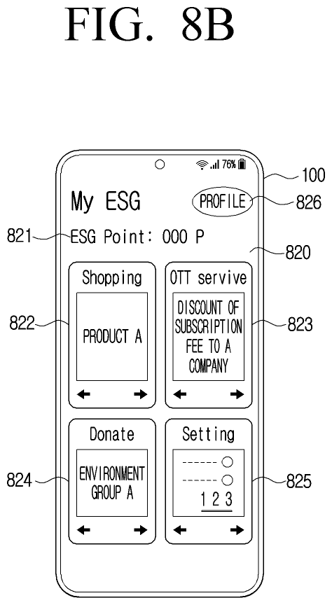

FIG. 7A, FIG. 7B, FIG. 8A, and FIG. 8B are diagrams illustrating a UI according to an embodiment.

According to an embodiment, depending on implementation examples of the electronic device 100, an ESG reward management function may be provided through an application. For example, the processor 130 may provide a UI for using a user reward in at least one service provided by a third party through an application. For example, the at least one service may include at least one of a product purchase service, a subscription purchase service, or a donation service.

According to an embodiment, as illustrated in FIG. 7A, FIG. 7B, in case the electronic device 100 is implemented as a TV or a smartphone, the ESG reward management function may be provided through an ESG application provided on the screen as illustrated in FIG. 7A (a TV) and FIG. 7B (a smartphone).

FIG. 8A is a diagram illustrating a form of a UI that is provided in case the electronic device 100 is implemented as a TV according to an embodiment. When the ESG application 710 is selected on the screen illustrated in FIG. 7A, the UI 810 as illustrated in FIG. 8A may be provided.

For example, the UI 810 may include ESG points 811 stored in the user's account, a menu 812 for product purchase, a menu 813 for receiving a discount on a subscription fee to the affiliated OTT service company, a menu 814 for donation to an environment group, a setting menu 815, a profile menu 816, etc. For example, if the receive buttons 612, 622 are selected on the UIs 610, 620 illustrated in FIG. 6A and FIG. 6B, ESG points may be interlocked with the user's ESG application account and stored. Afterwards, when the user accesses the TV application 710 or the smartphone application 720 and logs on to the ESG account, the received ESG points may be identified through the UIs as illustrated in FIG. 8A and FIG. 8B.

FIG. 8B is a diagram illustrating a form of a UI that is provided in case the electronic device 100 is implemented as a smartphone according to an embodiment. When the ESG application 720 is selected on the screen illustrated in FIG. 8A, the UI 820 as illustrated in FIG. 8B may be provided. As illustrated in FIG. 8B, the UI 820 may include menus 821, 822, 823, 824, 825, 826 in similar forms to those in FIG. 8A. For example, the user may select the menus 821, 822, 823, 824, 825, 826 through a touch input. However, this is merely an example, and the same information can obviously be implemented in a different design.

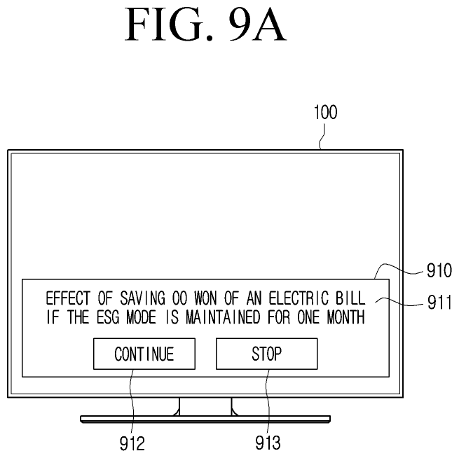

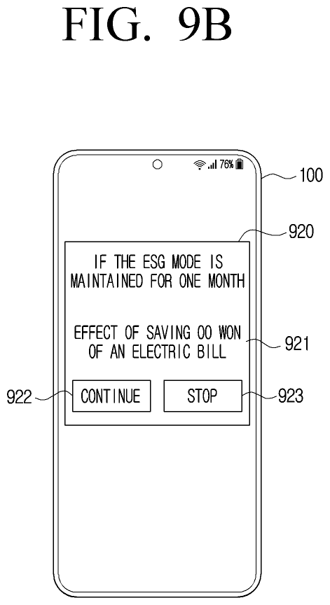

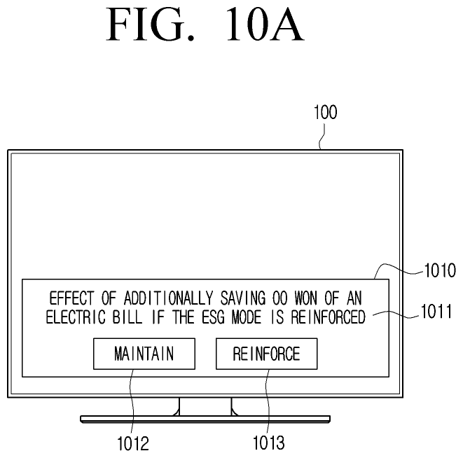

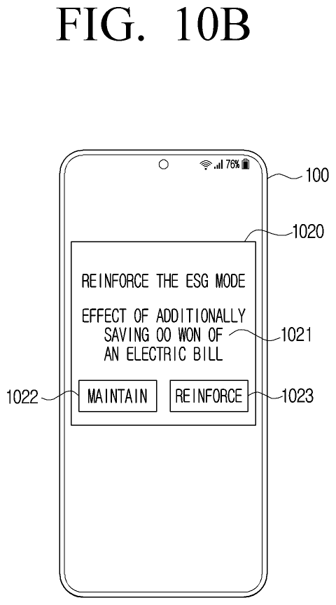

FIG. 9A, FIG. 9B, FIG. 10A, and FIG. 10B are diagrams illustrating a UI according to an embodiment.

According to an embodiment, the processor 130 may provide a feedback UI that can receive a user feedback regarding whether to maintain or stop the ESG mode and whether to maintain or change (e.g., reinforce or weaken) the ESG level. The processor 130 may turn off the ESG mode, or maintain or reinforce (or weaken) the ESG level according to a user feedback received through the feedback UI. For example, if reinforcement of the ESG level is selected, the ESG level may be reinforced by one level. However, in case the current level is the level of the biggest strength, the reinforcement button on the UI may be inactivated.

FIG. 9A, FIG. 9B, FIG. 10A, and FIG. 10B illustrate a feedback UI for selecting whether to maintain and/or reinforce a selected ESG level according to an embodiment.

According to an embodiment, a feedback UI may include a predicted value of additional information according to the predetermined reference viewing time and a menu for selecting whether to maintain and/or reinforce the ESG level. The additional information may include at least one of an effect of reduction of an electric bill, an effect of reduction of carbon, or an effect of planting trees, but hereinafter, explanation will be described by assuming a case wherein the additional information is an effect of reduction of an electric bill. For example, the UI illustrated in FIG. 9A, FIG. 9B, FIG. 10A, and FIG. 10B may be provided subsequently after a reward compensation method was selected in the UIs illustrated in FIG. 6A and FIG. 6B, but is not necessarily limited thereto.

FIG. 9A is a diagram illustrating a form of a feedback UI that is provided in case the electronic device 100 is implemented as a TV according to an embodiment. As illustrated in FIG. 9A, the first feedback UI 910 may include a predicted value of additional information such as an effect of saving 00 won of an electric bill if the ESG mode is maintained for one month. Also, the first feedback UI 910 may include menu buttons 912, 913 by which continuing and stopping of the ESG mode can be selected. For example, the user may select the menu buttons 912, 913 that can be selected through a remote control device. However, the UI illustrated in FIG. 9A is merely an example, and the same information can obviously be implemented in a different design.

FIG. 9B is a diagram illustrating a form of a feedback UI that is provided in case the electronic device 100 is implemented as a smartphone according to an embodiment. As illustrated in FIG. 9B, the first feedback UI 920 may include menu buttons 921, 922, 923 in similar forms to those in FIG. 9A. For example, the user may select the menus 922, 923 that can be selected through a touch input. However, this is merely an example, and the same information can obviously be implemented in a different design.

FIG. 10A is a diagram illustrating a form of a second feedback UI that is provided in case the electronic device 100 is implemented as a TV according to an embodiment. As illustrated in FIG. 10A, the second feedback UI 1010 may include a predicted value of additional information such as an effect of saving 00 won of an electric bill if the ESG mode is reinforced. Also, the second feedback UI 1010 may include menu buttons 1012, 1013 by which continuing and stopping of the ESG mode can be selected.

According to an embodiment, the second feedback UI 1010 may be provided in case the continue 912 is selected in the first feedback UI 910 illustrated in FIG. 9A, but is not necessarily limited thereto. If the maintain button 1012 is selected in the second feedback UI 1010, the current ESG level may be maintained, and if the reinforce button 1013 is selected, the ESG level may be reinforced (or risen) by one level. However, the disclosure is not limited thereto, and if the reinforce button 1013 is selected, a UI wherein the user can select a desired ESG level may be provided. Alternatively, a level selection button may be provided instead of the reinforce button 1013.

FIG. 10B is a diagram illustrating a form of a feedback UI that is provided in case the electronic device 100 is implemented as a smartphone according to an embodiment. As illustrated in FIG. 10B, the second feedback UI 1020 may include menu buttons 1021, 1022, 1023 in similar forms to those in FIG. 10A. According to an embodiment, the second feedback UI 1020 may be provided in case the continue 922 is selected in the first feedback UI 920 illustrated in FIG. 9B, but is not necessarily limited thereto.

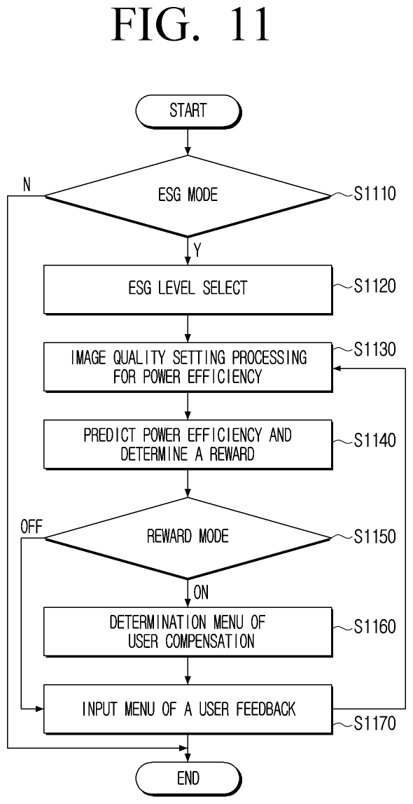

FIG. 11 is a diagram for illustrating a method of implementing an ESG mode according to an embodiment.

According to FIG. 11, if an ESG mode is selected in the step S1110: Y, and an ESG level is identified in the step S1120, the processor 130 may identify image quality setting processing for power efficiency corresponding to the selected level in the step S1130.

Then, the processor 130 may predict power efficiency based on the identified image quality setting processing and determine a reward in the step S1140.

Then, when the reward mode is turned on in the step S1150, the processor 130 may provide a determination menu of user compensation in a form of a pop-up UI in the step S1160. For example, the processor 130 may provide a determination menu of user compensation in a form of a pop-up after the predetermined reference viewing time passes. The determination menu of user compensation may include menu buttons such as receive points, donate points, etc.

Afterwards, the processor 130 may provide an input menu of a user feedback in a form of a pop-up UI in the step S1170. For example, when compensation is determined through the pop-up UI provided in the step S1160, the processor 130 may provide the input menu of a user feedback. The input menu of a user feedback may include menu buttons such as continue (maintain the level), reinforce (reinforce the level), stop, etc.

According to the aforementioned various embodiments, a power consumption reduction technology that extends a power saving effect not only to the brightness of a display but to the overall image quality improvement algorithm in consideration of a user feedback can be provided. Also, through indication of the actual power saving effect as numerical values, and a compensation system in this regard, motivation for use of a power saving mode can be provided to the user, and the consumer can be induced to ultimately contribute to ESG.

Meanwhile, the methods according to the aforementioned various embodiments of the disclosure may be implemented in forms of applications that can be installed on conventional electronic devices. Alternatively, the methods according to the aforementioned various embodiments of the disclosure, e.g., identification of a power saving event may be performed by using an artificial neural network based on deep learning (or a deep artificial neural network), i.e., a learning network model.

Also, the methods according to the aforementioned various embodiments of the disclosure may be implemented just with software upgrade, or hardware upgrade of conventional electronic devices.

In addition, the methods according to the aforementioned various embodiments of the disclosure may be performed through an embedded server provided on an electronic device, or an external server of an electronic device.

Meanwhile, according to an embodiment of the disclosure, the aforementioned various embodiments may be implemented as software including instructions stored in machine-readable storage media, which can be read by machines (e.g., computers). The machines refer to devices that call instructions stored in a storage medium, and can operate according to the called instructions, and the devices may include an electronic device according to the aforementioned embodiments (e.g., an electronic device A). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

Also, according to an embodiment of the disclosure, the methods according to the aforementioned various embodiments may be provided while being included in a computer program product. A computer program product refers to a product, and it can be traded between a seller and a buyer. A computer program product can be distributed in the form of a storage medium that is readable by machines (e.g., a compact disc read only memory (CD-ROM)), or distributed on-line through an application store (e.g., Play Store™). In the case of on-line distribution, at least a portion of a computer program product may be stored in a storage medium readable by machines such as the server of the manufacturer, the server of the application store, and the memory of the relay server at least temporarily, or may be generated temporarily.

In addition, each of the components (e.g., a module or a program) according to the aforementioned various embodiments may consist of a singular object or a plurality of objects. Also, among the aforementioned corresponding sub components, some sub components may be omitted, or other sub components may be further included in the various embodiments. Alternatively or additionally, some components (e.g., a module or a program) may be integrated as an object, and perform functions that were performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

The above-described embodiments are merely specific examples to describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An electronic device comprising:
a display;
memory storing instructions, and image quality processing information for each of a plurality of power consumption reduction levels; and
at least one processor operatively connected with the display and the memory,
wherein the at least one processor is configured to execute the instructions to:
identify a power consumption reduction amount corresponding to a selected level among the plurality of power consumption reduction levels based on the image quality processing information,
identify a user reward based on the identified power consumption reduction amount, and
control the display to display information about the identified user reward.

2. The electronic device of claim 1, wherein the at least one processor is further configured to execute the instructions to:
provide a user interface (UI) for selecting the selected level among the plurality of power consumption reduction levels through the display,
identify a plurality of image quality elements corresponding to the selected level based on the image quality processing information,
identify power consumption reduction amounts corresponding to the plurality of image quality elements, and
identify a final power consumption reduction amount by combining the identified power consumption reduction amounts.

3. The electronic device of claim 1, wherein the at least one processor is further configured to execute the instructions to:
based on a viewing time being equal to or greater than a predetermined reference viewing time, provide a user reward based on a power consumption reduction amount corresponding to the predetermined reference viewing time and a user interface (UI) for selecting a compensation method of the user reward through the display, and
based on the compensation method of the user reward being selected through the UI, process the user reward according to the selected compensation method.

4. The electronic device of claim 3, wherein the at least one processor is further configured to execute the instructions to:
based on the user reward being processed, provide a feedback UI for selecting at least one of whether to maintain or change the selected level through the display, and
re-execute a power consumption reduction mode according to a user instruction received through the feedback UI.

5. The electronic device of claim 1, wherein the image quality processing information comprises control information corresponding to each power consumption reduction level for a plurality of image quality processing elements, and
wherein the plurality of image quality processing elements comprise at least one of driving processing, contrast ratio processing, motion processing, noise processing, sharpness processing, or color processing.

6. The electronic device of claim 5, wherein the at least one processor is further configured to execute the instructions to:
identify power consumption reduction amounts for each hour of viewing time based on the control information for each image quality processing element corresponding to the selected level,
identify a final power consumption reduction amount based on the power consumption reduction amounts for each hour of viewing time and a predetermined reference viewing time, and
determine a predicted value of additional information according to the final power consumption reduction amount as the user reward.

7. The electronic device of claim 6, wherein the additional information comprises at least one of an effect of reduction of an electric bill, an effect of reduction of carbon, or an effect of planting trees.

8. The electronic device of claim 7, wherein the at least one processor is further configured to execute the instructions to, based on the viewing time being equal to or greater than the predetermined reference viewing time, control the display to provide a user interface (UI) including information on the predicted value of the additional information and the user reward.

9. The electronic device of claim 1, wherein the at least one processor is further configured to execute the instructions to control the display to provide a UI for using the user reward for at least one service provided from a third party, and
wherein the at least one service comprises at least one of a product purchase service, a subscription purchase service, or a donation service.

10. The electronic device of claim 1, wherein the at least one processor is further configured to execute the instructions to:
based on a power consumption reduction mode being turned on, automatically activate a lowest level among the plurality of power consumption reduction levels, and
based on a level among the plurality of power consumption reduction levels being selected, identify image quality processing information corresponding to the selected level.

11. A method for reducing power consumption of an electronic device, the method comprising:
identifying a power consumption reduction amount corresponding a selected level among a plurality of power consumption reduction levels based on image quality processing information;
identifying a user reward based on the identified power consumption reduction amount; and
displaying information about the identified user reward.

12. The method for reducing power consumption of claim 11, wherein the identifying the power consumption reduction amount comprises:
providing a user interface (“UI”) for selecting the selected level among the plurality of power consumption reduction levels through the display;
identifying a plurality of image quality elements corresponding to the selected level based on the image quality processing information;
identifying power consumption reduction amounts corresponding to the plurality of image quality elements; and
identifying a final power consumption reduction amount by combining the identified power consumption reduction amounts.

13. The method for reducing power consumption of claim 11, further comprising:
based on a viewing time being equal to or greater than a predetermined reference viewing time, providing a user reward based on a power consumption reduction amount corresponding to the reference viewing time and a UI for selecting a compensation method of the user reward; and
based on the compensation method of the user reward being selected through the UI, processing the user reward according to the selected compensation method.

14. The method for reducing power consumption of claim 13, further comprising:
based on the user reward being processed, providing a feedback UI for selecting at least one of whether to maintain or change the selected level; and
re-executing a power consumption reduction mode according to a user instruction received through the feedback UI.

15. A non-transitory computer readable medium storing computer instructions which, when executed by at least one processor of an electronic device, cause the electronic device to perform operations comprising:
identifying a power consumption reduction amount corresponding to a selected level among a plurality of power consumption reduction levels based on image quality processing information;
identifying a user reward based on the identified power consumption reduction amount; and
displaying information about the identified user reward.

16. The non-transitory computer readable medium of claim 15, wherein the identifying the power consumption reduction amount comprises:
providing a user interface (“UI”) for selecting the selected level among the plurality of power consumption reduction levels through the display;
identifying a plurality of image quality elements corresponding to the selected level based on the image quality processing information;
identifying power consumption reduction amounts corresponding to the plurality of image quality elements; and
identifying a final power consumption reduction amount by combining the identified power consumption reduction amounts.

17. The non-transitory computer readable medium of claim 15, wherein the operations further comprising:
based on a viewing time being equal to or greater than a predetermined reference viewing time, providing a user reward based on a power consumption reduction amount corresponding to the reference viewing time and a UI for selecting a compensation method of the user reward; and
based on the compensation method of the user reward being selected through the UI, processing the user reward according to the selected compensation method.

18. The non-transitory computer readable medium of claim 17, wherein the operations further comprising:
based on the user reward being processed, providing a feedback UI for selecting at least one of whether to maintain or change the selected level; and
re-executing a power consumption reduction mode according to a user instruction received through the feedback UI.

19. The non-transitory computer readable medium of claim 15, wherein the image quality processing information comprises control information corresponding to each power consumption reduction level for a plurality of image quality processing elements, and
wherein the plurality of image quality processing elements comprise at least one of driving processing, contrast ratio processing, motion processing, noise processing, sharpness processing, or color processing.

20. The non-transitory computer readable medium of claim 19, wherein the identifying the power consumption reduction amount comprising:
identify power consumption reduction amounts for each hour of viewing time based on the control information for each image quality processing element corresponding to the selected level,
identify a final power consumption reduction amount based on the power consumption reduction amounts for each hour of viewing time and a predetermined reference viewing time, and
determine a predicted value of additional information according to the final power consumption reduction amount as the user reward.
